(19) United States
(12) Patent Application Publication
(10) Pub. No.: US 2020/0231372 A1
(43) Pub. Date: Jul. 23, 2020

(54) CAPSULE FOR A SOLUBLE AND NON-SOLUBLE PRODUCT, SUCH AS COFFEE AND ITS DERIVATIVES, TEA AND HERBAL TEAS AND BEVERAGES

(71) Applicant: PKA SOLUTIONS S.R.L., Bologna (IT)

(72) Inventor: Carlo Alberto PARISE, Teolo (IT)

(21) Appl. No.: 16/650,579

(22) PCT Filed: Sep. 21, 2018
(86) PCT No.: PCT/EP2018/075571

§ 371 Date: Mar. 25, 2020

(30) Foreign Application Priority Data
Sep. 27, 2017 (IT) 102017000107829
Jan. 18, 2018 (IT) 102018000001267

(51) Int. Cl. B65D 85/804; B65D 65/46; A47J 31/44

(52) U.S. Cl. CPC B65D 85/8043; A47J 31/4492; B65D 65/466

(57) ABSTRACT

A capsule for a soluble and non-soluble product, such as coffee and its derivatives, tea and herbal teas and beverages, provided with a tray-like body made of plastic material and a film that closes the tray. The capsule includes a substance that can be detected by a sensor and is embedded in the plastic material of the tray.

### TECHNICAL FIELD

The present disclosure relates to a capsule for a soluble product, such as for example coffee and its derivatives, tea or herbal teas, beverages, broth or the like.

The disclosure is applied at home in the field of machines for instant beverages, but it can also be used in other fields, such as for example bars, hotels and restaurants.

### BACKGROUND

In recent years apparatuses for making hot and cold instant beverages have become considerably widespread.

The companies that manufacture these machines have tried to gain greater footholds also in the market of beverages, for example coffee, by each providing their own capsule usable, due to its shape, uniquely by the specific machine for which was provided.

Such capsules have a tray-like body made of plastic or metallic material, which is generally frustum-like and closed in an upper region and in some cases also in a lower region by a single film or by a polylaminate made of plastic or metallic material with or without a barrier function and in some cases previously microperforated. This film can be pierced at the moment of the beverage dispensing (if the film is microperforated, this operation might not be performed). In other cases the upper part of the capsule can be closed by a rigid lid made of plastic material.

With the diffusion of compatible capsules, that are provided with the same shape as the originals but sold at more competitive prices, companies that manufacture the original machines and capsules have sought systems for detecting the originality of the capsule that were unrelated to shape.

A capsule detection system is based on a color reader, capable of detecting the particular waveform of a color of a portion of the upper film of the capsule.

However, the color of the original capsule can be reproduced rather easily also on compatible capsules.

In order to overcome this drawback, some companies have started to produce capsules with two portions of the film that are characterized by different colors. In this case the machine must detect the combination of two colors by analyzing the two portions affected by the upper film.

The capsule detection system, both the one-color and two-color type, is complicated due to the presence of at least three elements: a proximity device, which detects the presence or not of a capsule in the dispensing compartment; a light emitter, for each colored portion, adapted to illuminate a colored portion of the film; and a sensor for detecting reflected light, for each colored portion of the film, capable of detecting color.

As an alternative to this capsule detection system there are sensors based on reading a code, for example a bar code. An identifying code of a particular type of original capsule is printed on the film or on the lateral wall of the tray and is read by a scanner when the capsule is inserted in the dispensing compartment.

Even this type of system, however, has drawbacks, since the code must be applied to the film or to the capsule, or printed on it, after its provision, generating further costs and production times.

Furthermore, the issues related to the protection and safeguard of the environment are felt increasingly by public opinion and governments.

In order to reduce the environmental impact of waste, they are in fact starting to impose increasingly restrictive regulations aimed at waste recycling, biodegradability and compostability.

For this reason, it is necessary to find an alternative to currently known capsules, made of non-recyclable materials, which are thus disposed of by storage in landfills among non-recyclable waste.

### SUMMARY

The aim of the present disclosure is to provide a capsule for soluble product, of the beverage type, that is capable of improving the prior art in one or more of the above mentioned aspects.

Within this aim, the disclosure provides a capsule for soluble product, of the beverage type, that can be detected by a particular type of machine for which it is produced in a simple manner and with systems that are less complex than the ones commercially available.

The disclosure also provides a capsule for soluble product, of the beverage type, that is detectable by a particular type of machine for which it is produced, that can be provided quickly and easily.

The present disclosure further provides a beverage dispensing machine that is capable of detecting and using a capsule for soluble product, of the beverage type, according to the disclosure.

The disclosure provides a capsule for soluble product, of the beverage type, that can be disposed of among organic waste after use.

The present disclosure overcomes the drawbacks of the prior art in a manner which is alternative to any existing solutions.

The disclosure also provides a capsule for soluble product that is highly reliable, relatively easy to provide and at competitive costs.

This aim, as well as these and other advantages which will become better apparent hereinafter, are achieved by providing a capsule for soluble and non-soluble product, such as coffee and its derivatives, tea and herbal teas, having a tray-like body made of plastic material and a film that closes the tray, characterized in that it comprises, embedded in said plastic material of the tray, a substance that can be detected by a sensor.

### BRIEF DESCRIPTION OF THE DRAWINGS

Further characteristics and advantages of the disclosure will become better apparent from the description of a preferred but not exclusive embodiment of the capsule for soluble product according to the disclosure, illustrated by way of non-limiting example in the accompanying drawings, wherein:

FIG. 1 is a view of a capsule according to the disclosure in an active step of the dispensing machine; and

FIG. 2 is a view, merely by way of non-limiting example, of a dispensing machine for a capsule according to the disclosure.

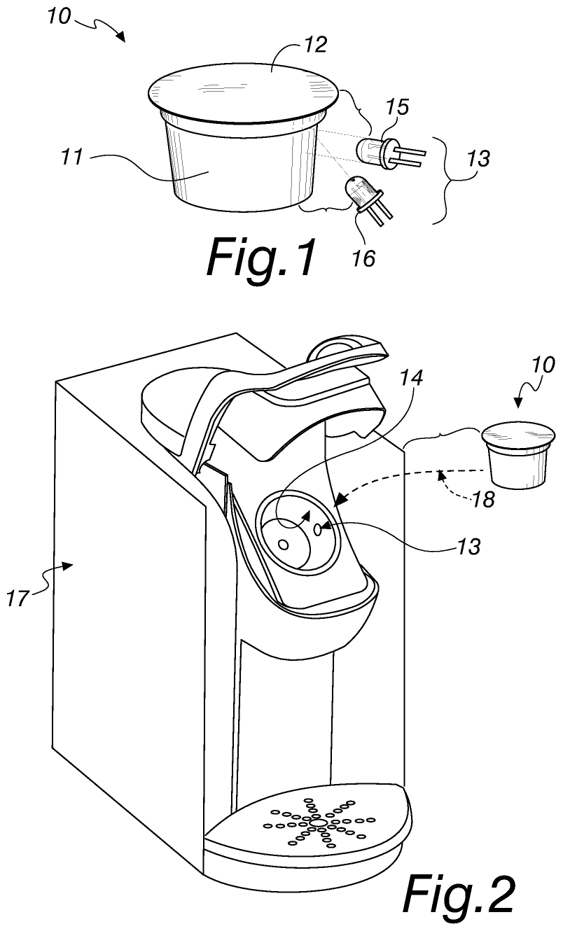

### DETAILED DESCRIPTION OF THE DRAWINGS

With reference to the above figures, a capsule for soluble product according to the disclosure is generally designated by reference numeral 10.

The capsule 10 has a tray-like body 11 made of plastic or metallic material, which is generally frustum-shaped and is closed in an upper region and in some cases also in a downward region by a single or polylaminated film 12 made of plastic or metallic material with or without a barrier function and in some cases previously microperforated. This film 12 can be pierced at the time of beverage dispensing (if the film is microperforated, this operation might not be performed). In other cases the upper part of the capsule can be closed by a rigid lid made of plastic material.

The tray-like body 11 is made of plastic material, such as for example polypropylene.

In particular, the plastic material of which the film 12 and/or the lid of the tray-like body 11 are both made is at least biodegradable and preferably compostable.

The term “biodegradable” is understood to reference the capacity of a material to be degraded into simpler substances by means of the enzymatic activity of microorganisms.

The term “compostable” means what is defined by the EN 13432 standard of 2002, and in particular that a material must have the following characteristics:
degrade by at least of 90% in six months if subjected to an environment rich in carbon dioxide, these values must be tested with the EN 14046 standard method;
in contact with organic materials for a period of three months, the mass of the material must be constituted for at least 90% by fragments with dimensions smaller than 2 mm, such values must be tested with the EN 14045 standard method;
the material must not have negative effects on the composting process;
low concentration of heavy metals added to the material;
values of pH within the limits set by the standard;
salinity within the limits set by the standard;
concentration of volatile solids within the limits set by the standard;
concentration of nitrogen, phosphorus, magnesium and potassium within the limits set by the standard.

In particular, the compostability and/or biodegradability of the plastic material of which the film 12 and/or lid and the tray-like body 11 are made is detectable by means of a sensor.

A particularity of the disclosure resides in the composition of the tray 11 and in its production method.

The tray 11 made of plastic material is provided, for example, by means of thermoforming from a sheet under pressure or by injection in adapted molds. A substance that can be detected by a sensor is dispersed and/or embedded within said plastic material.

Said sensor is, for example, an infrared detection sensor.

The substance is, preferably, homogeneously distributed and its quantity is such to make it detectable by the sensor 13.

The raw material of said substance is, for example, a powder or a substance in liquid form, mixed in a matrix of the base material of the tray 11.

The detection technology is based, for example, on the infrared conversion of a signal deriving from a material with microscopic particles. Said particles are embedded in a matrix and are stimulated by an infrared radiation in order to be detected. The detector is specific for the detection of the electromagnetic absorption and/or reflection of said type of material.

One substance that can be used as tracer in said plastic material of the tray 11 is, for example, one of those of the series known by the trade name “Securalic Reveal” of the company Merck Performance Materials, or the like.

With reference to the figures, in order to dispense beverages the capsule is introduced in a machine 17, in the case of this example a coffee machine, in a capsule holding compartment 14 as indicated by the arrow 18.

The capsule holding compartment 14 has, on the inner lateral walls, a detection sensor 13, for example of the infrared type.

The sensor 13 comprises a signal emitter 15 and a signal receiver 16, which can also coincide and face the lateral wall of the tray 11 of the capsule 10.

Once the capsule 10 has been introduced in the compartment 14, the emitter 15 emits a particular radiation toward the tray 11, which reflects it at least partially. The reflection is read by the receiver 16, which is capable of reading a particular waveform associated with the composition of the original capsule.

If the capsule is original, the mentioned substance, dispersed and/or embedded in the plastic material of the tray 11, determines a specific reflection of the radiation. When the receiver 16 detects said specific reflection of the radiation, it generates a signal for starting the dispensing of the beverage.

In the case of an unauthorized capsule, the absence of said substance in the plastic material of the tray 11 entails a different or failed reflection of the radiation emitted by the emitter 15, with respect to the one generated by the original capsule, with subsequent blocking of dispensing.

The beverage dispensing system is per se known.

It should be noted that the presence of a substance detectable by a sensor in the plastic material of the tray determines an easier provision of the capsule, since such substance is dispersed in the base material of the tray, without complicating nor varying substantially the method for its provision.

It should also be noted that the presence of a substance detectable by a sensor in the plastic material of the tray allows to provide dispensing machines with capsule detection systems that are simpler than those currently known.

In practice it has been found that the disclosure achieves the intended aim and advantages by providing a capsule for soluble and non-soluble product, such as coffee and its derivatives, tea and herbal teas, having a tray-like body made of plastic material and a film that closes the tray, characterized in that it comprises, embedded in said plastic material of the tray, a substance that can be detected by a sensor.

The disclosure thus conceived is susceptible of numerous modifications and variations, all of which are within the scope of the appended claims; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Applications No. 102017000107829 and No. 102018000001267 from which this application claims priority are incorporated herein by reference.

1-13. (canceled)

14. A capsule for a soluble and non-soluble product, such as coffee and its derivatives, tea and herbal teas and beverages, the capsule comprising: a body made of plastic material and a film that closes the body, and comprising, embedded in said plastic material of the body, a substance configured to be detected by a sensor.

15. The capsule according to claim 14, wherein said substance is a powder.

16. The capsule according to claim 14, wherein said substance is initially in liquid form.

17. The capsule according to claim 14, wherein said substance is one of the Securalic Reveal series of the company Merck Performance Materials, or the like.

18. The capsule according to claim 14, wherein said sensor is infrared.

19. The capsule according to claim 14, wherein said film is provided by a thin film of plastic and/or metallic material and/or by superimposition of continuous microperforated and non-microperforated layers of plastic and metallic material.

20. The capsule according to claim 14, wherein said body is closed in an upper region by a rigid lid made of plastic material.

21. The capsule according to claim 19, wherein said plastic material of which said film and/or said lid and said body are made is an at least biodegradable and preferably compostable material.

22. The capsule according to claim 14, wherein said body made of plastic material is provided by thermoforming from a sheet under pressure or by injection in adapted molds.

23. A dispensing machine using a capsule according to claim 14, comprising a capsule holding compartment, and further comprising a sensor on an internal side walls of said compartment, which faces said body, for detecting said substance.

24. The machine according to claim 23, wherein said sensor comprises a signal emitter and a signal receiver.

25. The machine according to claim 24, wherein said signal emitter and said signal receiver coincide.

26. The machine according to claim 23, wherein said sensor is of the infrared type.
